(19) United States
(12) Patent Application Publication
(10) Pub. No.: US 2007/0222334 A1
(43) Pub. Date: Sep. 27, 2007

(54) MICROELECTROMECHANICAL STEP ACTUATOR CAPABLE OF BOTH ANALOG AND DIGITAL MOVEMENTS

(76) Inventor: Chang-Feng Wan, Dallas, TX (US)

Correspondence Address: CHANG-FENG WAN, 16210 SHADYBANK DRIVE, DALLAS, TX, 75248, US

(21) Appl. No.: 11/277,479

(22) Filed: Mar. 24, 2006

(51) Int. Cl. H01G 5/01; G02B 26/00; H02N 1/00

(52) U.S. Cl. 310/309; 361/278; 359/290

(57) ABSTRACT

An embodiment of the present invention provides a step actuator, comprising a suspended membrane comprising a plurality of movable electrodes connected by plurality of spring hinges to a payload platform; and pillars connecting said membrane to a substrate, said substrate comprising a plurality of fixed electrodes; wherein said movable electrodes of said suspended membrane and said fixed electrodes from said substrate form parallel-plate electrostatic sub-actuators. Another embodiment of the present invention provides controlled operation of the step actuator over its entire range of motion, by avoiding its instability region and both digital and analog operations with enhanced stroke. It comprises a suspended membrane comprising a plurality of fixed electrodes, a plurality of movable electrodes connected by plurality of spring hinges to a medial payload platform. The fixed electrodes comprise insulator stops that keep the movable electrodes from entering the unstable region.

### BACKGROUND

Electrostatic forces have been used to move structures. Traditional electrostatic actuators were constructed from two planar electrodes that are parallel to each other and are separated by a vacuum, or “air” gap, wherein one of the electrodes is movable against the other. When a voltage or charge is supplied between the respective electrodes, an electrostatic force is created that can cause the movable electrode and its payload to move. The electrical circuits that are used to supply the voltage or charge are called voltage drive and charge drive (U.S. Pat. No. 6,829,132), respectively.

MEMS actuators using electrostatic actuators as means of moving, shaping or actuating a payload are integral part of many, if not most Micro-Electro-Mechanical Systems (MEMS). They have low power consumption and small size. These include parallel-plate actuator, cantilever actuator, torsion drive, comb drive, rotary motor, zipper drive, and scratch drive. Of these, parallel-plate actuator generates strict vertical (out-of-plane) displacement. A schematic of the prior-art parallel-plate actuator is shown in FIG. 1A, which comprises a movable electrode 10, a fixed electrode 20, spring 82 as hinges, a pair of pillars 30 on substrate 1. The movable electrode 10 is suspended by the spring hinges 82, which have a spring constant k, and is substantially parallel to the fixed electrode 20 with an air gap gₒ in between. When a voltage Vᵢₙ is applied between the two electrodes, it gives rise to a force F and a displacement that can be calculated by the following equations:

$$F = \frac{ɛ \cdot A \cdot {V}_{i n}^{2}}{2 {g}^{2}} and g = {g}_{0} - \frac{ɛ \cdot A \cdot {V}_{i n}^{2}}{2 k \cdot {g}^{2}} \qquad EQ . 1$$

Where g is the instantaneous air gap, ε is dielectric constant, A is area of the smaller electrode. Note that this is now a cubic equation for the gap. As we increase the voltage, the air gap decreases, with the amount of decrease growing as the air gap gets smaller. Thus there is positive feedback in this system, and at some critical voltage, the system goes unstable, and the air gap collapses to zero. This phenomenon is called “pull-in”. The air gap at which the pull-in occurs is called pull-in gap, which is approximately ⅔ of gₒ the original (zero bias) air gap. This gap separates the regions of stable and unstable operations. The voltage where the pull-in occurs is

$${V}_{PI} = \sqrt{\frac{8 k \cdot {g}_{o}^{3}}{27 ɛ \cdot A}} \qquad EQ . 2$$

The parallel-plate actuator can be configured as a cantilever torsion actuator as shown in FIG. 1B, where one side of the movable plate of the electrostatic actuator is hinged on a torsion beam while the other side is free to move. The movable plate will tilt when an electrostatic force is applied. There is a pull-in angle, defined as the maximum angle a electrostatic torsion actuator's movable electrode can tilt around the torsion beam before becoming unstable (susceptible to pull-in). It can be determined by the following equation (Jiang Zhe et al. “Analytic Pull-in Study on Non-deformable Electrostatic Micro Actuators” MSM2002):
θₚᵢ=0.44·tan⁻¹(gₒ/L),

where gₒ is the zero-bias gap between the two electrodes; L is the lateral length of the movable electrode. The height of the free end of the movable electrode at the pull-in angle is calculated by
hₚᵢ=gₒ−L1·tan θₚᵢ

where L1 is the lateral distance of the insulator bump from the hinge. It can be seen that hₚᵢ˜0.56 gₒ. The (pull-in) phenomena severely restrict the tuning range of the actuator. They also diminish the output force, due to the fact that the air gap cannot be smaller than that for the unstable region where the electrostatic force can be much higher.

Methods to reduce the pull-in gap so to increase the tuning range of parallel-plate electrostatic actuators exist one method is to connect a series capacitor, having ˜½ to 2 times the actuator's zero-bias capacitance (in un-actuated state), to the electrostatic actuator to form a voltage divider that provides negative feedback to help stabilize the system. The stabilized range as a fraction of the air gap is dependent on the capacitance and the series capacitor used. This usage has been described in U.S. Pat. No. 6,480646 B2 for extending the travel range of the actuator. The principle is described by Edward K. Chan and Robert W. Dutton. In “Electrostatic Micromechanical Actuator with Extended Range of Travel,” JOURNAL OF MICRO-ELECTRO-MECHANICAL SYSTEMS, VOL. 9, NO. 3, 2000, p. 321. For example, if 50% stabilization region is required, the series capacitor should have 2 times the actuator's zero-bias capacitance. Another method includes controlling the amount of charge injected into the two parallel electrodes of the parallel-plate electrostatic actuator instead of controlling the voltage. Assuming a fixed amount of charge Q can be injected into the actuator, to induce a displacement of the movable electrode. The energy U stored in a capacitor with a charge Q is Q²/2C, where C is the capacitance. The actuation force is then given by the partial derivative of the store energy with respect to the displacement at constant charge:
Fₐ=∝U/∝x=½(∝Q²/C∝x)=½∝(g/εA)/∝x·Q²=Q²/2·ε·A EQ. 3

Where g is the air gap, ε is the electric constant, and A is the area of the sub-actuator's capacitor. As can be seen in EQ. 3, the force is independent of the air gap of the capacitor. This theoretically reduces the pull-in gap to <20% of the zero-bias air gap; permits stable operation for >80% of the air gap (JOURNAL OF MICROELECTRO-MECHANICAL SYSTEMS, VOL. 11, NO. 3, pp. 196 JUNE 2002). This allows the deflection to be extended to close to the full air gap. Although charge drive mode of operation can extend the tuning range to ˜80% of the air gap, it is desirable to extend it further. In addition, the output force of electrostatic actuators must be improved. According to EQ. 1, electrostatic forces is inversely proportional to the air gap squared; the output force is small unless the air gap is restricted to less than 3 micrometers. One way of increasing the output force and/or stroke is to use the zipper actuator whose movable electrode is flexible and curled Actuators (Joan Pons-Nin, et. al. JOURNAL OF MICROELECTROMECHANICAL SYSTEMS, VOL. 6, NO. 3, SEPTEMBER 1997 257). However, the curvature and flexibility of the curled electrode is difficult to control during device processing and fabrication, and the operation suffers from hysteresis effects. The effect was due in part to the charge buildup between the movable and the fixed electrodes in the unstable region that must be discharged into the stable region before the electrodes can be separated.

### SUMMARY OF THE INVENTION

An embodiment of the invention provides a parallel-plate electrostatic actuator that is capable of realizing vertical (to the surface of the substrate) displacements in precise, incremental steps. Each step motion is due to the pull-in of at least one series of interconnected sub-actuators, which comprise parallel-plate electrostatic actuators having graduated air gaps. The sub-actuators in a series are actuated in a sequential, incremental manner to move the payload. The operation can be digital in nature in that actuation is done by applying a voltage higher than the pull-in voltages so that their upper, movable electrodes come in contact with the fixed electrodes. This moves the rest of movable electrodes one incremental air gap, reduces the air gaps, lowers the pull-in voltage, and increases the actuating force in a fashion similar to the zipper actuators. Each step of the incremental displacement is dependent on incremental step height of the fixed electrodes. The actuator can also be in analog fashion which is achieved by adding pillars or stops whose height that is >⅔ of the air gap on between the top and bottom electrodes of the sub-actuator. This prevents the top electrode from being pulled-in for the specific sub-actuator in action. Only ˜⅓ of the air gap, which can be continuously controlled in analog fashion, is utilized in each sub-actuator to constitute the full-range of displacement.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a prior-art electrostatic actuator.

FIG. 1B is a prior-art cantilever torsion electrostatic actuator.

FIG. 2A is a perspective view of a MEMS step actuator of the present invention.

FIG. 2B is a top view of a MEMS step actuator according to the present invention;

FIG. 3 is cross-sectional views of the MEMS step actuator shown in FIG. 2A and FIG. 2B;

FIG. 3A is cross-sectional views of a MEMS step actuator having fixed electrodes form on the same plane and between the substrate and insulator stairs;

FIG. 3B is top view of preferred configuration of the spring hinges for the step actuator;

FIG. 4 is a cross-sectional view of the MEMS step actuator embodiment of FIG. 2A wherein the outer-most (1^{st}) pair of sub-actuators is actuated to move the payload platform 60 downward one step;

FIG. 5 is a cross-sectional view of the MEMS step actuator embodiment of FIG. 2A wherein the first and the second sub-actuator pairs are actuated to move the payload platform one step further downward from its position from that shown in FIG. 4.

FIG. 6A is a plain view of insulator pillars surrounded by a matrix of fixed electrode;

FIG. 6B is a cross-sectional view of a preferred insulator pillars configuration;

FIG. 7A is a cross-sectional view of an left half of the analog step actuator embodiment in original position;

FIG. 7B is a cross-sectional view of the analog step actuator embodiment of FIG. 7A, where a voltage has been applied to move the payload platform 1 step downward;

FIG. 7C is a cross-sectional view of the analog step actuator embodiment of FIG. 7A wherein a voltage has been applied to move the payload platform further downward with the additional actuation of the 2^{nd} sub-actuator;

FIG. 7D is a cross-sectional view of the analog step actuator embodiment of FIG. 7A when the full actuation of the first three sub-actuators and partial actuation of the 4^{th} sub-actuator;

FIG. 8 is a plain of left-half of a torsional MEMS step actuator;

FIG. 8A is a cross-sectional side view of the un-actuated torsional actuator shown in FIG. 8.

FIG. 8B is a cross-sectional side view of the torsional actuator, whose 1^{st} sub-actuator is actuated.

FIG. 8C is a cross-sectional side view of the torsional actuator, whose 1^{st} and 2^{nd} sub-actuators are fully actuated, and the 3^{rd} sub-actuator is partially actuated.

FIG. 9A is a cross-sectional view of a step actuator having coplanar waveguide as a sub-actuator;

FIG. 9B is a top view of the step in FIG. 9A having coplanar waveguide as a sub-actuator;

FIG. 10 is a top view of a 3 DOF (degrees of freedom) actuator employing three series of sub-actuators.

FIG. 11A is top view of the turning staircase embodiment of the step actuator.

FIG. 11B is cross sectional view of the turning staircase embodiment of the step actuator.

FIG. 11C is top view of the staircase of the turning-staircase step actuator.

FIG. 11D is a perspective view of turning staircase of the turning-staircase step actuator.

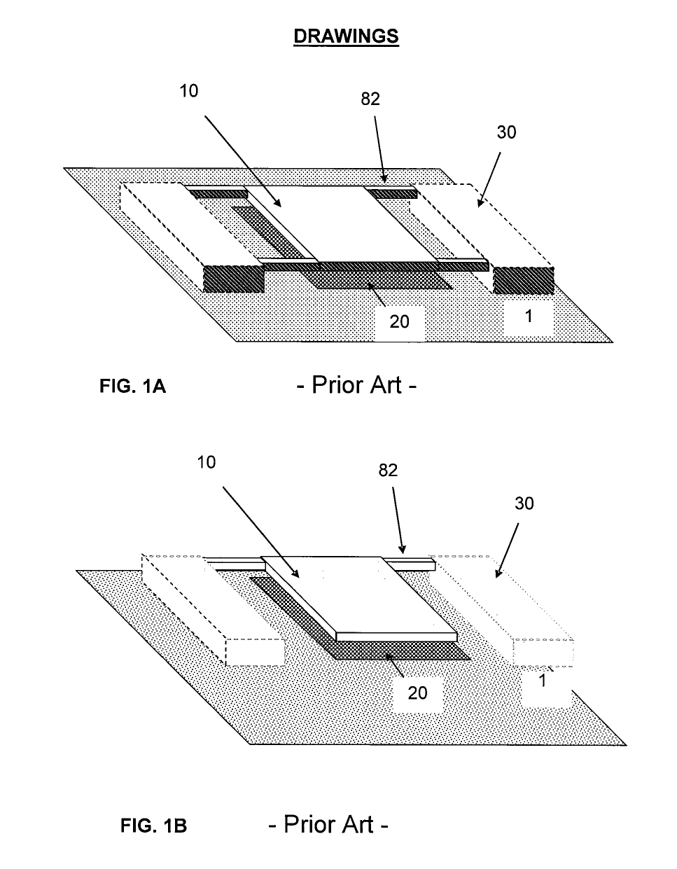

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention. Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art. An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

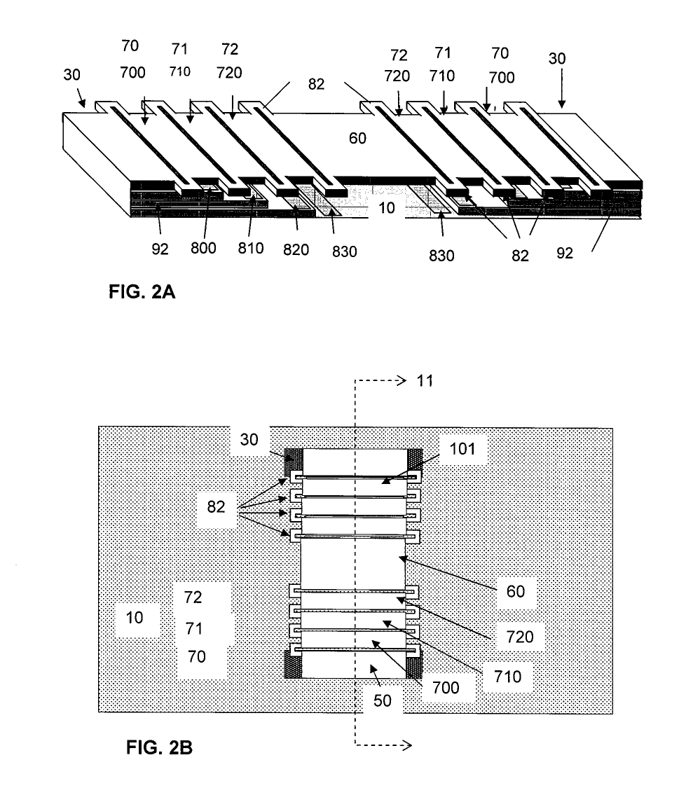

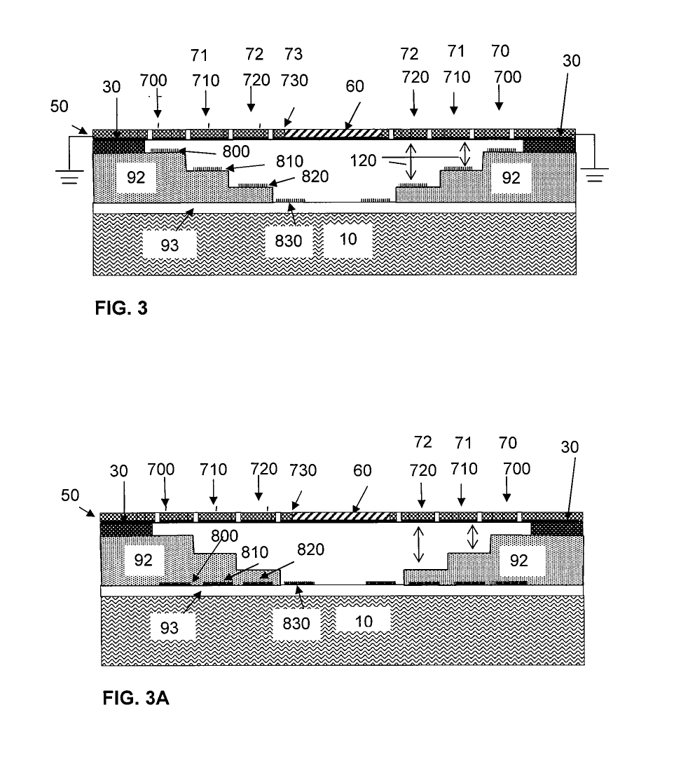

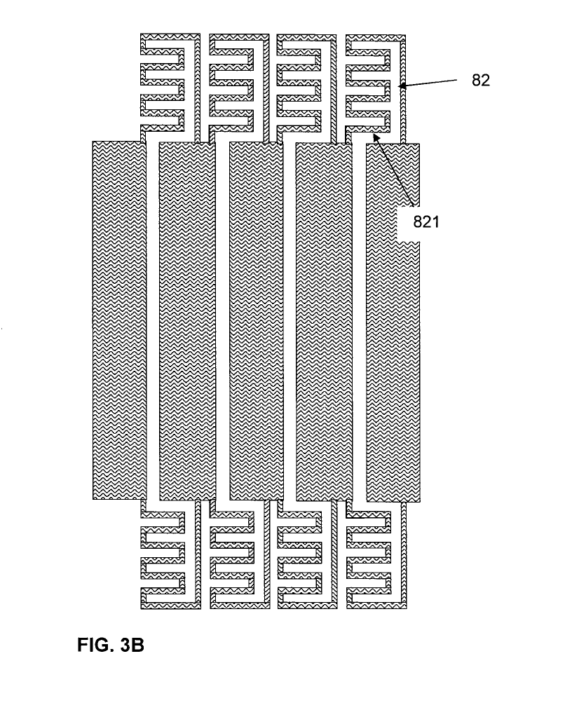

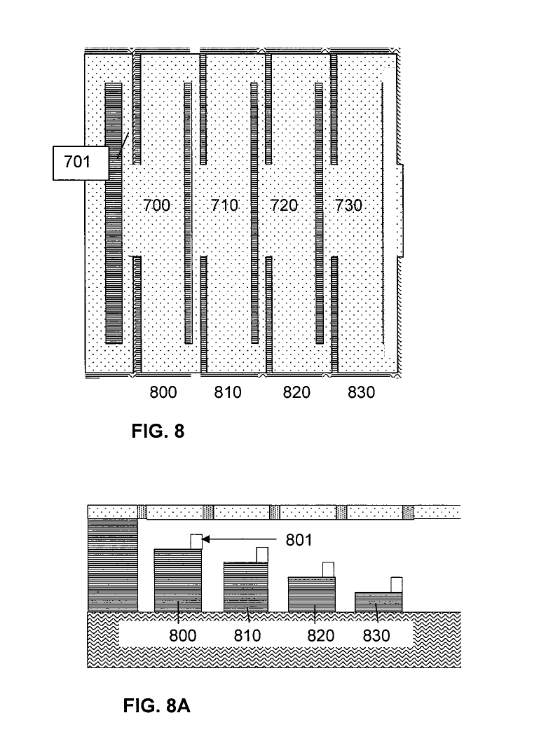

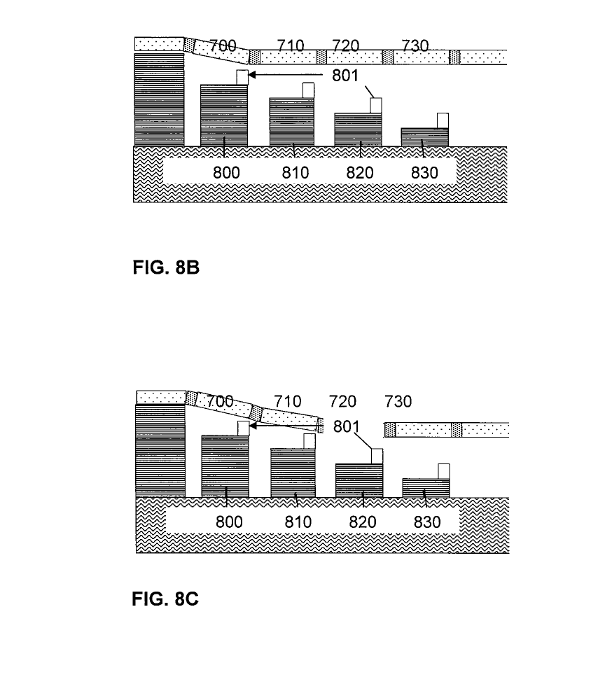

The present invention is shown schematically in FIG. 2A, which depicts perspective view of the present invention step actuator as described in application Ser. No. 11/028,409. Its plain view is shown in FIG. 2B, and cross-sectional view in FIG. 3. The invention provides a MEMS parallel-plate, electrostatic step actuator that comprises a substrate 10, two insulator stairs 92 on the opposite sides of a payload platform 60, separate fixed electrodes 800, 810, 820, 830 on the steps of the insulator stairs 92, and on the substrate, respectively, and a suspended membrane 50. The suspended membrane 50 is generally planar and is preferably made of electrically conductive material; it comprises a payload platform 60, movable electrodes 700, 710, and 720, and spring hinges 82, which link the movable electrodes 700, 710, 720 to form series or series of movable electrodes. The movable electrodes 700, 710, 720, 730 and the fixed electrodes 800, 810, 820, 830 pair to form parallel-plate electrostatic sub-actuators 70, 71, 72, and 73 on both sides of the payload platform 60. Not shown are insulator stops that keep the movable electrodes from coming into electrical contact with the fixed electrodes if pull-in occurs. The suspended membrane 50 or substantially all the movable electrodes are preferably electrically connected together and grounded; while the fixed electrodes are biased with voltages individually or collectively. The air gaps of the parallel-plate electrostatic sub-actuators 70, 71, 72 and 73 are the distance between the two electrodes as determined by the height of the fixed electrodes and the height of the suspended membrane 50. The air gaps are preferably, but not necessarily of equal increments, such as g₀, 2gₒ, 3gₒ, and 4gₒ, etc., thereby the air gaps are graduated with increment gₒ. The sub-actuators, 70, which are closest to the pillars 30, have the smallest air gap gₒ; the next sub-actuators 71 have twice the air gap 2gₒ, and the third sub-actuators 72 have air gap 3 gₒ, and so on for the subsequent sub-actuators. An alternative to forming graduated air gaps is shown in FIG. 3A, where the fixed electrodes are formed on the substrate and beneath the insulator stairs 92. The insulator stairs are preferably but not necessarily made of high-k (dielectric constant) dielectric material, such as Si3N4 (silicon nitride, k=7.5) or BST (barium strontium titanate, k=15-25). The high dielectric constants k drastically reduces the thickness t of the dielectric material by a factor of k, i.e. reduces it to t/k. Although the distance between the movable and the fixed electrodes are the same for all the sub-actuators, the effective air gap for the capacitor becomes gₒ+t/k, which is graduated as the thickness t is graduated. It should be noted that instead of insulators, the stairs can be made of individual metal blocks of different thicknesses. One such example will be shown in FIG. 8A thru 8C, where fixed electrodes 800, 810, 820, and 830 are made of individual block of metal of different thicknesses.

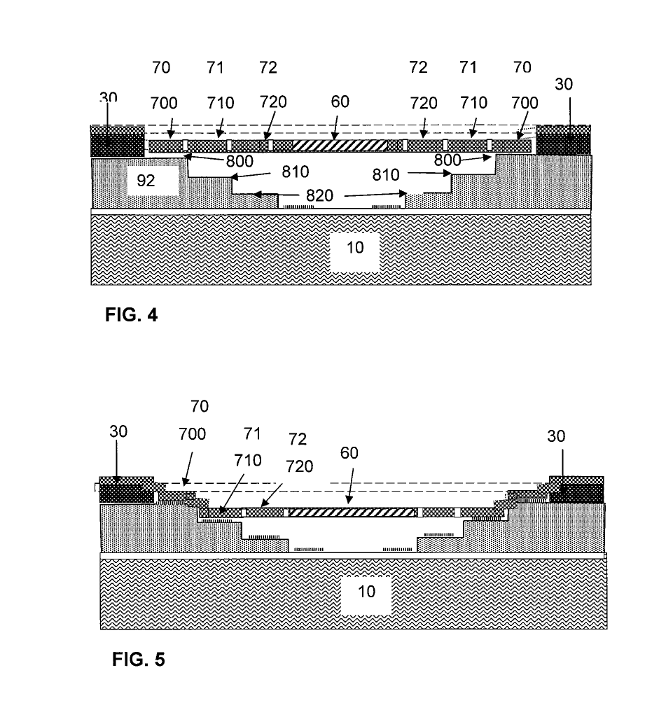

FIG. 3B shows a preferred embodiment of the spring hinges 82, which comprise meanders whose span beams 821 are in the horizontal direction as shown in FIG. 3B. This spring hinge configuration minimizes tilt of the movable electrodes. The actuation of a sub-actuator is preferably done by connecting the suspended membrane to electrical ground while applying on the fixed electrode a voltage that exceeds the pull-in voltage of the sub-actuator to actuate the sub-actuator 70 as shown in FIG. 4, where movable electrodes 700 of the sub-actuator pair 70 of the step actuator are pulled in. The required voltage V_{PI} for the sub-actuators 70, given by EQ. 2, is much lower than a conventional electrostatic actuator with the same overall air gap (3gₒ); only ⅓^{3/2} (19%) of the latter. It can also be seen in FIG. 4 that after the sub-actuator pair 70 is actuated, the rest of the movable membrane 50, including movable electrodes 710, 720 and payload platform 60, is moved closer to the substrate 10 and the fixed electrodes 810, 820, 830 by a distance of gₒ. That is, the air gap of sub-actuator pair 71 decreases from its zero-bias air gap of, for example, 2gₒ, to gₒ, and the payload platform is moved an incremental distance of gₒ. Now the step actuator is ready to move the payload platform another step, and the actuation voltage of the sub-actuator pair 71 is governed by its increment air gap gₒ, instead of its original one (2gₒ, for example). Thus, the incremental air gap of a specific sub-actuator is defined as the air gap of the sub-actuator after the preceding sub-actuators are pulled in, but before the specific sub-actuator is activated. Thus the actuation voltage remains the same as that of sub-actuator pair 70, having an air gap of gₒ. When sub-actuators pair 71 are actuated, as shown in FIG. 5, the rest of movable electrodes 720 and the payload platform are again moved a distance of gₒ closer to the fixed electrodes 820 and the substrate 10. Thus by the same token, the air gap for the sub-actuator pair 72 decreases another notch (gₒ) to gₒ and the actuation voltage becomes that corresponds to gₒ accordingly, instead of 3gₒ, its zero-bias air gap. Thus the step actuator is operated in digital mode. And by actuating the sub-actuators in sequence, the payload platform is displaced incrementally while keeping the force high and/or actuation voltages lower than possible with a single actuator. The amount of incremental displacement is determined by the step heights of the sub-actuators and the sub-actuators state of actuation. Thus the step actuator, when operated in the digital mode, has the following characteristics: (1) Consists of a plurality of parallel-plate electrostatic actuators with distinct air gaps; (2) Inputs are in digital format or on-off fashion; (3) Movement of payload is in discrete steps; (4) Actuation voltage is low; (5) Output force is large; (6) Amount of displacement is extended, and (7) Displacement is notched in the actuator; While the exemplary step actuator given herein comprises only 3 to 4 sub-actuators and steps, substantially more of them can be implemented to further extend the displacement of actuation.

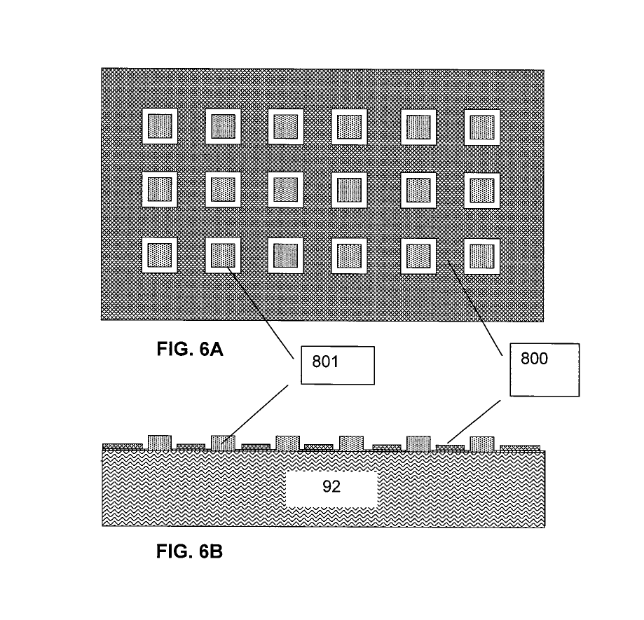

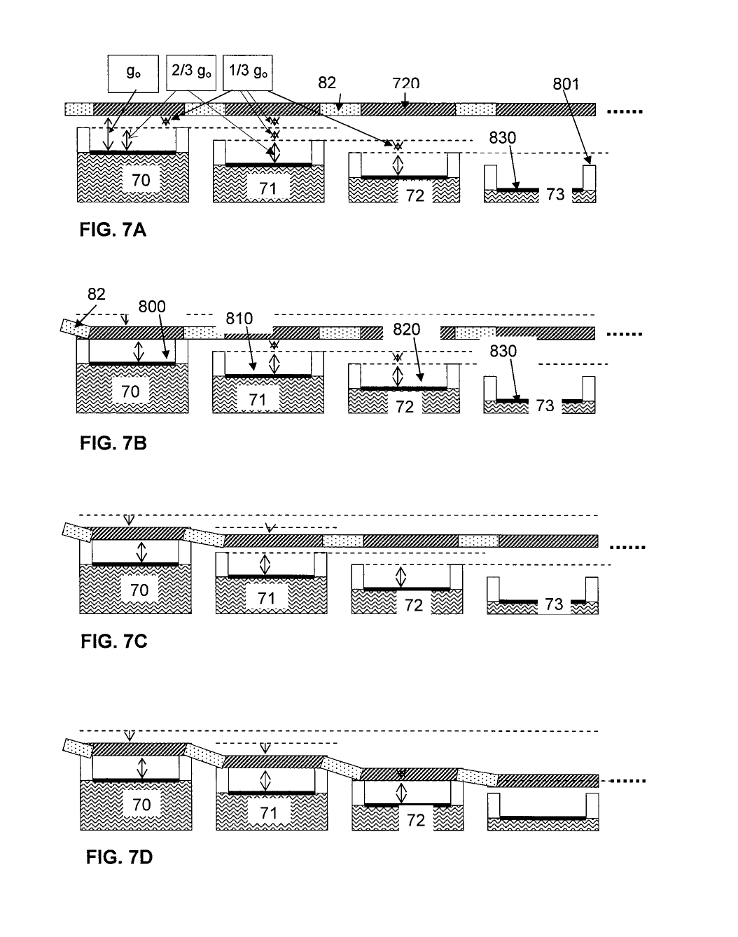

The fixed electrodes of the sub-actuators in FIG. 3 comprise insulator stops. A preferred embodiment is shown in plain view of FIG. 6A and cross-sectional view of FIG. 6B, wherein the fixed electrode 800 is perforated, i.e., having holes; and insulator stops 801 are formed in the perforation of the fixed electrode 800. The heights of the insulator stops are slightly taller than the unstable region of the respective sub-actuators to prevent the movable electrodes from entering the unstable region and slapping in. Size or area of the steps is preferably significantly smaller than the fixed electrodes. Thus the step actuator can be operated in analog mode, where the output displacement or output force is a continuous function of the applied voltage, when it is modified such that the sub-actuators only operates in their respective stable regions. In a preferred embodiment, the height of the insulator stops 801 is taller than unstable regions of the respective sub-actuators so that the movable electrodes do not enter the unstable regions. In the case of a parallel-plate electrostatic actuator with a voltage drive, the height of the insulator stop is 2/3 air gap. An exemplary step actuator is shown in FIG. 7A to 7D, where a series of four sub-actuators comprising individual insulator blocks 70-73 and fixed electrodes 800-830 thereon, is shown; not shown are the medial payload platform and the other series of sub-actuators, which works in concert. The step actuator is assumed to employ voltage drives, the height of the insulator spacer or stops are set at ˜⅔ of the respective air gaps, and the height of the stair steps are staggered by ˜⅓ of the respective air gaps. Once the first sub-actuator 70 is fully actuated to its full ⅓ air gap of displacement as shown in FIG. 7B, its voltage is put on a hold, and the 2^{nd} sub-actuator 71 takes over. It is actuated to take control the 2^{nd} displacement of ˜⅓ of the incremental air gap. Similarly, the next sub-actuator pair 72, when equipped with similar insulator stops, provides the third segment (⅓ of its air gap) of displacement, and so on. Thus the range of the stable region with controllable displacement can be extended to beyond that of a conventional parallel plate actuator. In the exemplary step actuator, the height of the insulator stops is set to ⅔ of the air gap because it is the stable region of electrostatic sub-actuators with charge drives, although the effective range of displacement is reduced by a factor of ⅔. If the charge drive was used where the stable region of the sub-actuators could be increased to ˜80% of the respective air gaps, the height of the insulator stops would be ˜20% of the respective air gaps, the steps of the stair steps are staggered by >80% of the respective air gaps, and the effective range of displacement is reduced by <20%, from the combined range of all the sub-actuators.

In another embodiment of the step actuator, the fixed electrodes 800, 810, 820 and 820 in FIG. 3 and FIG. 3A are electrically interconnected together to operate as one electrode 80, as shown in FIG. 7A, while the movable electrodes are already interconnected and operated as one. Thus only one voltage or charge drive is needed to drive the step actuator. When a voltage or a fixed amount of charge is supplied to the capacitors formed by the movable electrodes 70 and fixed electrodes 80, the payload platform will be displaced. This arrangement can be used to generate a slightly larger amount of force and/or displacement of the payload platform because all the sub-actuators are actuated. Since all the sub-actuators are connected in parallel, the total capacitance C_{Total} is the sum of all the sub-actuators. Thus

$$\begin{matrix}{C}_{Total} = ɛ \cdot A \cdot ( 1 / g + 1 / 2 g + 1 / 3 g + 1 / 4 g ) \\ = ɛ \cdot A \cdot \frac{2.08}{ g} \\ = 2.08 \cdot {C}_{o}\end{matrix} \qquad EQ . 4$$

i.e., the capacitance of a four-tiered step actuator is approximately twice that of a single sub-actuator, Cₒ, thus about twice force can be produced with the same voltage.

An alternate operation of the step actuator is to utilize torsion operation of the step actuator, wherein the spring hinges of its electrostatic sub-actuators are configured to operate in torsion mode. FIG. 8 shows schematic top view of a section of the symmetric torsion step actuator, wherein the movable electrodes 700, 710, 720, 730, are connected with torsion beams 701. The fixed electrodes 800-803 have insulator stops 810 on one side to prevent the movable electrode from tilting more than its pull-in angle, as shown in schematic cross-sectional view in FIG. 8A. Pull-in angle θₚᵢ, is the maximum angle a electrostatic torsion actuator's movable electrode can reach before becoming unstable (susceptible to pull-in). It can be determined by the following equation: θₚᵢ=0.44 tan⁻¹(d/L), where d is the original gap between the two electrodes; L is the lateral length of the overlapped region between the movable and fixed electrodes and is normally the length of the fixed electrode. The height of the insulator bump is calculated by hₚᵢ=d−L1 tan θₚᵢ where L1 is the lateral distance of the insulator bump from the hinge. It can be seen that when L1=L, then hₚᵢ˜0.56d.

FIG. 8B depicts schematically the movable (tilt-able) electrode 700 is fully tilted when a voltage exceeding the pull-in voltage is applied on the fixed electrodes. FIG. 8C, on the other hand, shows the movable electrodes 700 and 701 are filly tiled, while 702 is partially tilted.

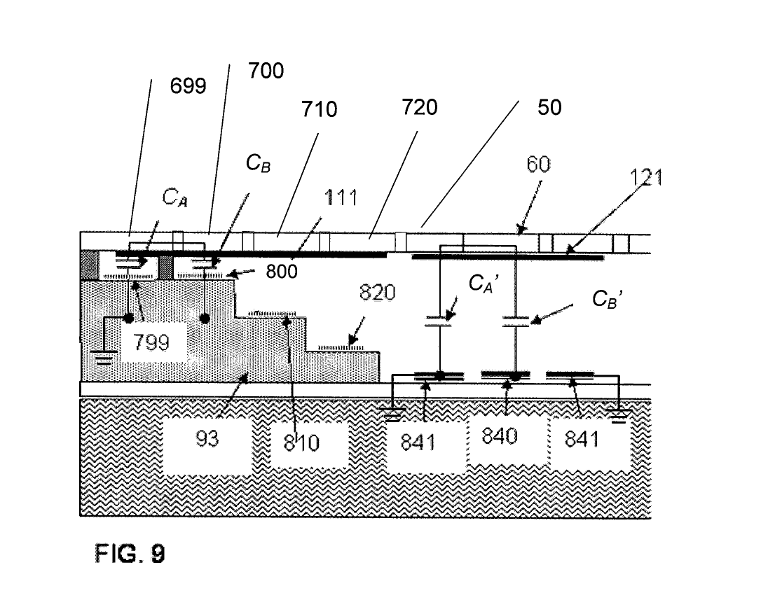

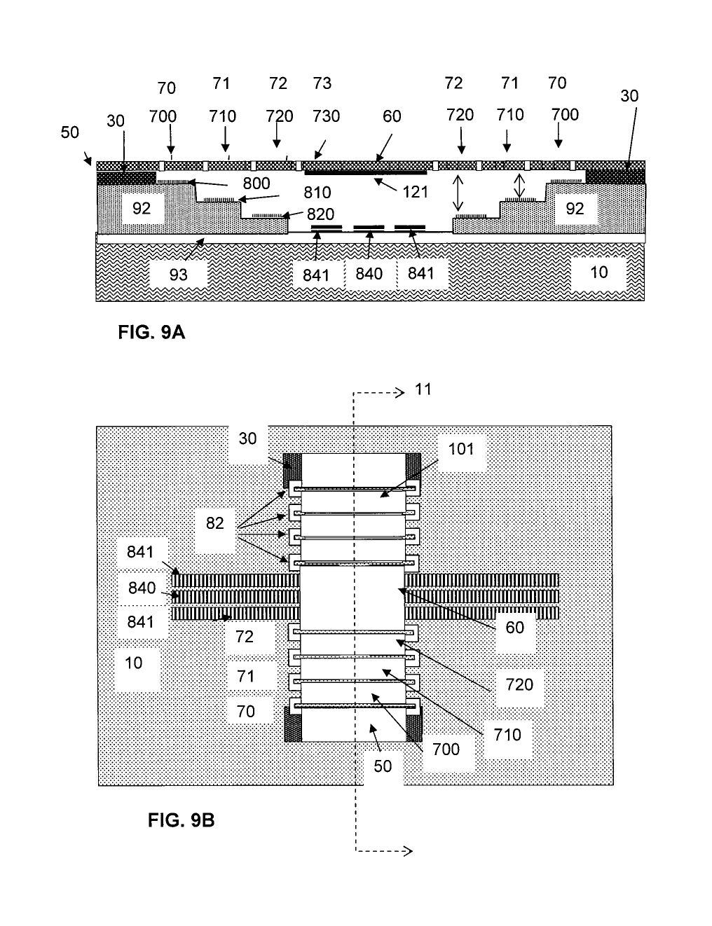

As mentioned before, an alternative to expand the stable region of the electrostatic actuator is to connect it to a series capacitor having half the capacitance value, so to provide a negative feedback to stabilize the system. Since there are several capacitors in the sub-actuators, this is applicable in the present step actuator. The sub-actuators can be connected in series, to create series capacitors for extending the stable region of a certain sub-actuator. The connections can be accomplished using switches and electronic circuits. Reference is now made to cross sectional view FIG. 9 of the left and center portion of the step actuator. The suspended membrane 50 is preferably made of high resistivity material. It comprises a stationary electrode 699 and movable electrodes 700, 710, 720 formed on the underside of 50, as well as electrode 121 on the underside of the payload platform 60. Field plates 699, 700, 710, and 720 are electrically interconnected by metal lines deposited on the underside of the spring hinges to form one group of field plates 111. In the preferred embodiment, field plate groups 111 and 121 are electrically floating. The movable electrode pair with the fixed electrodes 799, 800, 810, 820, 840, and 841 to form separate actuator/capacitors, i.e., 699-799, 700-800, 710-810, 720-820, 121-840, and 121-841. Any two of these capacitors can form series capacitors, i.e. be connected in series. The preferred configuration is shown in FIG. 9, in which circuit diagrams of capacitors overlap the cross sectional view. It can be seen that capacitor CA formed by fixed capacitor 699-799 is grounded from the fixed electrode 799, and is connected in series to capacitor C_{B}, which is formed by sub-actuator/capacitor 700-800. Two other sub-actuator/capacitors, 710-810 and 720-820, are also in series with 699-799, but are connected in parallel with 700-800. The capacitance C_{A} of the fixed capacitor 699-799 determines the amount of series capacitance coupled to the sub-actuators and thus the % range or initial air gap for the stable region of controlled actuation. It is noted that if C_{A} is very large, it behaves like a short, which can replace direct electrical contact.

One of the applications of the analog or digital step actuator is for making varactor (variable capacitor) in which the capacitance is varied, for radio frequency devices. In this application, the configuration shown in FIG. 9 is applied; the suspended membrane comprises high resistivity material and the medial payload platform 60 comprises a floating field plate 121 as shown in FIG. 9A. Fixed electrodes 840 and 841 form two capacitors with field plate 121; and in turn they form a series capacitor, whose capacitance can be varied by moving the payload platform. The preferred embodiment is shown in cross sectional view FIG. 9A and top view FIG. 9B. The bottom electrodes 840 and 841 traverses under the top electrode plate 121 and form coplanar waveguide in ground-signal-ground (GSG) configuration as shown in FIG. 9B. These fixed electrodes have insulator pillars as stop (not shown). The top electrode plate 121 is preferably floating, or not electrically connected to the top electrodes of the sub-actuators, to avoid stray capacitance. Then the capacitance of the variable capacitor is that of two capacitors connected in series, one (C_{B}′) formed between electrodes 840 and 121, the other one (C_{A}′) between 121 and 841. The metal line 841 can be made much wider than the metal line 840, thus the capacitance is close to that of electrodes 840 and 121. A bias voltage applied between metal lines 840 and 841 generates electrostatic force that makes them functions as a sub-actuator.

The above description generally relates to a medial payload platform having two series of sub-actuators on both sides that are operated at the same time and manner to realize one degree of freedom motion in the out-of-plane direction. In theory, the payload platform can achieve two degrees of freedom motion (DOF) if the two series of sub-actuators are operated independently; they will be the out-of-plane motion plus a tilt motion. If three series of sub-actuators are used in a configuration shown in top view FIG. 10, where they surround the payload platform 120 degrees apart on the same plane, three degrees of freedom can be achieved on the payload platform. This configuration can be used to adjust the out-of-plane motion as well as its orientations, and may be used for deformable mirrors in adaptive optics applications or beam steering.

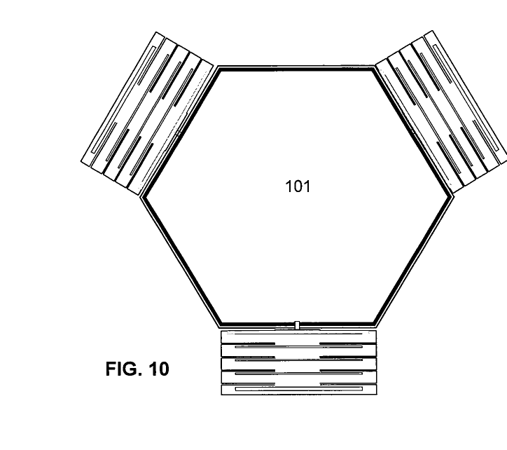

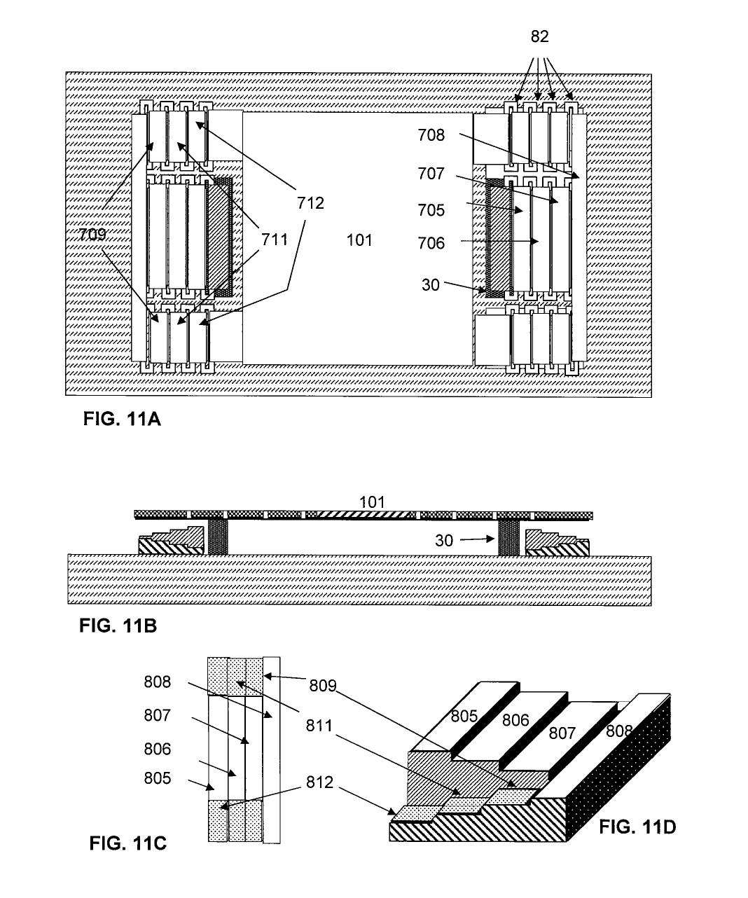

The stairs of a step actuator preferably have fewer than 5 steps, or the series of movable electrodes may become so extended that the suspended structure becomes less stiff and consumes too much lateral space. A turning stairs design shown in FIG. 11A to FIG. 11D may alleviate the situation allowing more steps to be employed without occupying too much lateral space. FIG. 11A is top view of the turning staircase embodiment of the step actuator, showing configuration of the movable electrodes 705-712, where 705-707 are medial movable electrodes and 709-712 are pairs that flank each medial movable electrode. 708 is the end movable electrode that represents the turning point of the turning stairs. FIG. 11B is cross sectional view of the turning staircase embodiment of the actuator. FIG. 11C is top view of the right turning staircase of the turning-staircase step actuator having steps 805-807 flanking step pairs 809-812, and right-end stair step(s) 808. They form sub-actuators with the movable electrodes 705-712, respectively. FIG. 11D is a perspective view of the right turning staircase of the turning-staircase step actuator. The method of actuation is similar to that described above for the step actuators, except that the direction of actuation is turned 180 degree at the right end or left end sub-actuator formed by electrodes on step 808 and step 708. This embodiment represents one turn or one fold of the step actuator. This turning or folding of the series of sub-actuators can be used in different turning angles or number of folds to achieve various application goals, such as winding stairs configuration.

What is claimed is:

1. An electrostatic step actuator, comprising a substrate and a membrane suspended on said substrate;
(1) said substrate further comprises a plurality of pillars, fixed electrodes, and insulator stops;
(2) said fixed electrodes form stairs;
(3) said insulator stops are formed on said fixed electrodes and have heights larger than or equal to 20% of the respective incremental height of the steps of said stairs;
(4) said suspended membrane further comprises a payload platform, a plurality of movable electrodes and a plurality of spring hinges;
(5) said movable electrodes are connected with said spring hinges to form at least one series of movable electrodes;
(6) one end of each said series of movable electrodes is connected to said payload platform, the other end is supported by at least one of said pillars;
(7) said fixed electrodes and said movable electrodes form a plurality of parallel-plate electrostatic sub-actuators having graduated air gaps.

2. The step actuator in claim 1, wherein said insulator stops have heights larger than or equal to 50% of the incremental step height of said stairs.

3. The step actuator in claim 1, wherein at least one of said sub-actuators are connected to a fixed capacitor in series.

4. The step actuator in claim 1, wherein at least two of said sub-actuator are connected in series.

5. The step actuator of claim 1, wherein said spring hinges comprise torsion beams.

6. The step actuator of claim 1, wherein said spring hinges comprise torsion beams, said insulator piers are on one side of said steps and have heights larger than or equal to d−L1·tan θₚᵢ wherein L1 is the lateral distance of the insulator bump from the hinge, d is the respective incremental step height of said stairs, and θₚᵢ is the pull-in angle of respective sub-actuators.

7. The step actuator of claim 1, wherein said suspended membrane comprises high resistivity material and said movable electrodes comprise interconnected metal field plates.

8. The step actuator of claim 7, wherein said interconnected metal field plates are electrically floating.

9. The step actuator of claim 8 wherein said suspended membrane further comprises a stationary metal field plate to form a fixed capacitor with a fixed electrode on said substrate, wherein one side of said fixed capacitor is grounded, and the other side is connected in series with the other sub-actuators of the series of sub-actuators.

10. The step actuator of claim 9 wherein the capacitance of said fixed capacitor is substantially larger than those of the sub-actuators.

11. The step actuator of claim 1, wherein
(1) said substrate further comprises a coplanar waveguide under said payload platform,
(2) said suspended membrane comprises high resistivity material;
(3) said payload platform comprises a metal field plate that is electrically floating and electrically isolated from said movable electrodes; and
(4) said metal field plate form capacitors with the ground lines and signal lines of said coplanar waveguide

12. The step actuator of claim 11, wherein at least one of said metal field plates is electrically floating and form at least two capacitors with said fixed electrodes.

13. The step actuator in claim 1, wherein the number of said series of sub-actuator is one and said payload platform is connected to said pillars with said spring hinges.

14. The step actuator in claim 1, wherein the number of said series of sub-actuator is two, and are oriented 180 degrees apart from each other around said payload platform.

15. The step actuator in claim 1, wherein the number of said series of sub-actuator is three, and are oriented 120 degrees apart from each other around said payload platform.

16. The step actuator in claim 1, wherein said fixed electrode is formed between said

17. Insulator stops and said substrate.

18. An electrostatic step actuator, comprising a substrate and a membrane suspended on said substrate;
(1) said substrate further comprises a plurality of pillars, fixed electrodes, and insulator stops;
(2) said fixed electrodes form stairs;
(3) said insulator stops are formed on said fixed electrodes;
(4) said suspended membrane further comprises a payload platform, a plurality of movable electrodes and a plurality of spring hinges;
(5) said movable electrodes are connected with each other in a series by said spring hinges to form at least one series of movable electrodes;
(6) one end of each said series of movable electrodes is connected to said payload platform, the other end is supported by at least one of said pillars;
(7) said fixed electrodes and said movable electrodes form a plurality of parallel-plate electrostatic sub-actuators having graduated air gaps.
(8) said stairs assume the shape of a folding, or winding staircase.
